(19) United States
(12) Patent Application Publication
(10) Pub. No.: US 2021/0056615 A1
(43) Pub. Date: Feb. 25, 2021

(54) ENHANCED SHOPPING USING MOBILE DEVICES AND MICRO-LOCATION DATA FOR IN-STORE ITEM PICK-UP BY A TRUSTED CONTACT

(71) Applicant: International Business Machines Corporation, Armonk, NY (US)

(72) Inventors: Rama Krishna Vedula, McKinney, TX (US); Lisa Seacat DeLuca, Baltimore, MD (US)

(21) Appl. No.: 16/546,645

(22) Filed: Aug. 21, 2019

(51) Int. Cl. G06Q 30/06; G06Q 10/08

(52) U.S. Cl. CPC G06Q 30/0639; G06Q 10/0836

(57) ABSTRACT

A method and system for enhancing shopping convenience using mobile devices and micro-location services for an item in-store pick-up by a remote user. The method and system includes sending, using a control system, to a device of a trusted contact, a notification for an item pickup at an in-store location. The method and system includes confirming, that the trusted contact has picked-up the item for the first user, and notifying the first user that the item has been picked-up.

### BACKGROUND

The present disclosure relates to a method and system for a trusted contact, or mutual trusted contacts, to collaborate, using mobile devices and micro-location data, to arrange for an in-store pick-up of one or more items.

Item in-store pick-up is popular as users shop on-line, typically using the Internet, and have the option of picking an item up at a store location. Such in-store pickup arrangements can be at retail establishments that can include, but not be limited to, a retailer, a pharmacy, or a grocery store. In one example, a user can shop and order one or more items on-line, using the Internet. Once selecting one or more items (before or after payment is made), the user can select in-store pickup as an option for receiving the item(s). The user can then proceed to pick-up the item by going to the physical location of the store to pick-up/receive the item.

An issue related to the above description is that when the user selects in-store pick-up, the user has to spend time to travel to the store to pick-up the item. This requires planning as well as time and effort on the part of the user which may not be convenient or efficient. In another example, a user can arrange for another person to pick up the item. Such an arrangement may include communicating with another person and arranging for them to pick-up the item. This can be an inconvenience to the other person as well as time consuming for both parties.

### SUMMARY

The present disclosure recognizes the shortcomings and problems associated with the lack of a mechanism or technique for individuals to pick-up items for users or shoppers when they have selected in-store pick-up. A method can include a trusted contact list (for example, but not limited to, friends, neighbors or family members), who can pick up items for a user when the user has purchased an item on-line and selected in-store pick-up. The trusted contact may be shopping or picking up items from a physical store and be able to, and in agreement with the user, pick-up items for the user. Thus, in one example, the method and system of the present disclosure can provide individuals who are already in a physical store, to pick-up items as a trusted contact of a user based on the user's shopping list. In one example, the trusted contact can receive payment via a social payment application. In another example, the user can pay for the item when selecting the item, prior to pick-up, or pre-pay for the item prior to picking-up the item.

In one aspect according to the invention, a method for enhancing shopping convenience using mobile devices and micro-location services for an item in-store pick-up by a remote user includes determining, using micro-location services, that a trusted contact for a remote user is in a location within a retail store corresponding to an in-store location of an item requiring in-store pick-up. The item is associated with the remote user. The method includes sending, using a control system, to a device of the trusted contact, a notification for an item pickup of the item requiring in-store pick-up. The method includes confirming, using the control system, that the trusted contact has picked-up the item for the first user; and notifying the first user, using the control system, that the item has been picked-up by the trusted contact.

In another aspect according to the present invention, a system for enhancing shopping convenience using mobile devices and micro-location services for an item in-store pick-up by a remote user includes a computer system. The computer system includes: a computer processor, a computer-readable storage medium, and program instructions stored on the computer-readable storage medium being executable by the processor, to cause the computer system to: determine, using micro-location services, that a trusted contact for a remote user is in a location within a retail store corresponding to an in-store location of an item requiring in-store pick-up wherein the item is associated with the remote user; send, using a control system, to a device of the trusted contact, a notification for an item pickup of the item requiring in-store pick-up, confirm, using the control system, that the trusted contact has picked-up the item for the first user; and notify the first user, using the control system, that the item has been picked-up by the trusted contact.

In another aspect according to the present invention, a computer program product for enhancing shopping convenience using mobile devices and micro-location services for an item in-store pick-up by a remote user. The computer program product comprising a computer readable storage medium having program instructions embodied therewith, wherein the computer readable storage medium is not a transitory signal per se, the program instructions executable by a computer to cause the computer to perform a method, comprising: determining, using micro-location services, that a trusted contact for a remote user is in a location within a retail store corresponding to an in-store location of an item requiring in-store pick-up wherein the item is associated with the remote user; sending, using a control system, to a device of the trusted contact, a notification for an item pickup of the item requiring in-store pick-up, confirming, using the control system, that the trusted contact has picked-up the item for the first user; and notifying the first user, using the control system, that the item has been picked-up by the trusted contact.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawing are discussed forthwith below.

FIG. 1 is a schematic block diagram illustrating an overview of a system and methodology for enhancing shopping convenience using mobile devices and micro-location services for an item in-store pick-up by a user, according to an embodiment of the invention.

FIG. 2 is a flow chart illustrating a method, implemented using the system shown in FIG. 1, for enhancing shopping convenience using mobile devices and micro-location services for an item in-store pick-up by a user, according to an embodiment of the present invention.

FIG. 3 is a flow chart illustrating another method continuing from the method shown in FIG. 2, for sending notifications from a control system.

FIG. 4 is an instructional and functional block diagram illustrating features of the present invention in association with the embodiments shown in FIGS. 1-3, for enhancing shopping convenience using mobile devices and micro-location services for an item in-store pick-up by a user.

FIG. 5 is a schematic block diagram depicting a computer system according to an embodiment of the disclosure which may be incorporated, all or in part, in one or more computers or devices shown in FIG. 1, and cooperates with the system and methods shown in FIGS. 1-4.

FIG. 6 is a schematic block diagram of a system depicting system components interconnected using a bus. The components for use, in all or in part, with the embodiments of the present disclosure, in accordance with one embodiment of the present disclosure.

FIG. 7 is a block diagram depicting a cloud computing environment according to an embodiment of the present invention.

FIG. 8 is a block diagram depicting abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

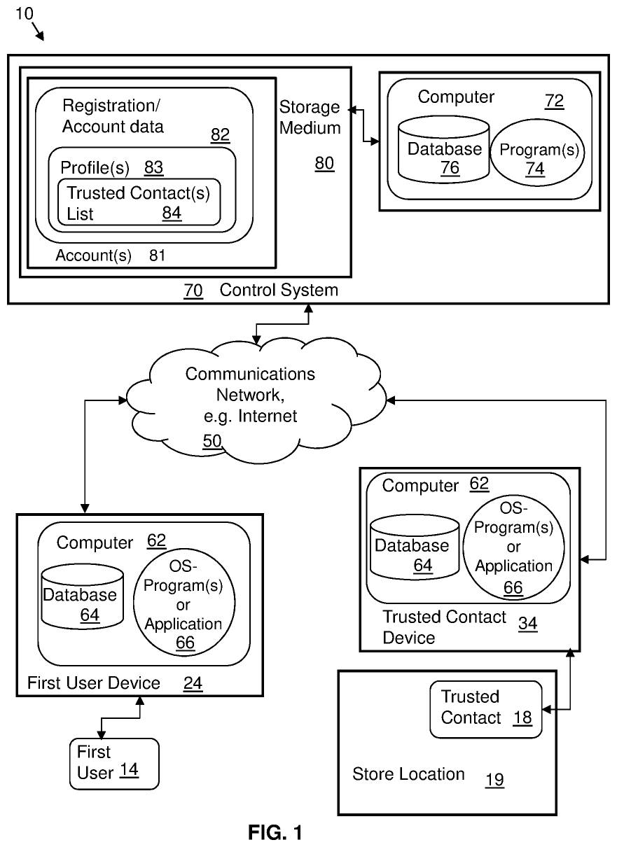

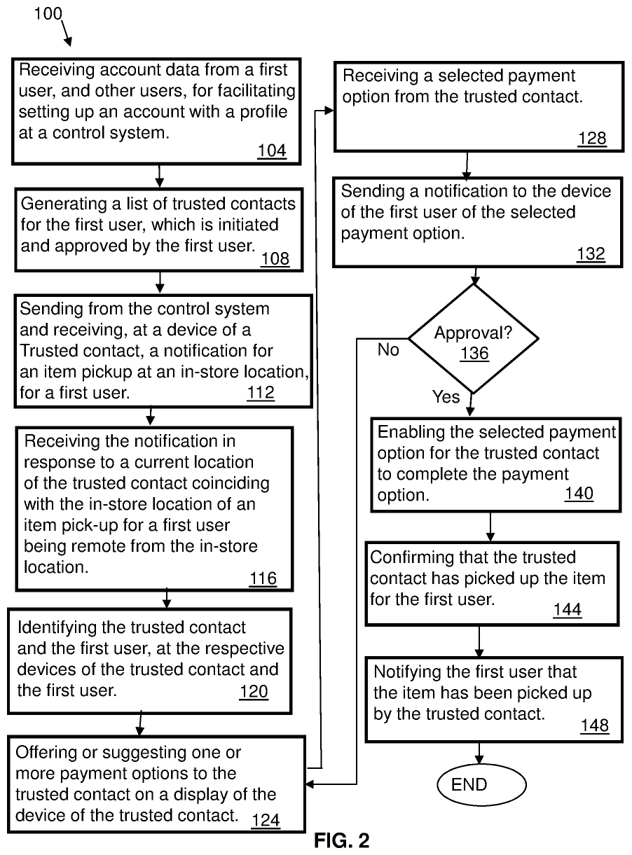

Referring to FIGS. 1 and 2, a method 100 (FIG. 2) with reference to a system 10 (FIG. 1) according to an embodiment of the present disclosure is provided for enhancing shopping using mobile devices and micro-location services for a trusted contact to pick-up or retrieve an item in a store, or in other words, an item in-store pick-up or retrieval by a trusted contact. The trusted contact is specified by a first user specifying one or more trusted contacts.

Referring to FIG. 2, the method 100 includes receiving account data 82 from a first user 14, and one or more other users, as in block 104. The account data 82 facilitates setting up an account 81 which includes a profile 83 at a control system 70, as in block 104. For instance, a first user can set up an account and profile 83 which includes one or more trusted contacts or a trusted contact list 84. The trusted contact list is generated for the first user and is initiated and approved by the first user, as in block 108. Other users can set up accounts and have one or more trusted contacts, and also be trusted contacts/users on other user's trusted contacts lists.

The profile 83 is saved in a computer readable storage medium 80 and/or in a database 76, which are shown in FIG. 1 as part of the control system 70. The control system 70 includes one or more programs 74. The programs 74 can be stored in a computer 72 of the control system 70. The program(s) 74 can include, all or in part, a series of executable steps for implementing the method of the present disclosure. A program, incorporating the present method, can be all or in part stored in the computer readable storage medium on the control system or, in all or in part, on a user device. It is envisioned that the control system can not only store the profile of users, but interact with a website for viewing on the Internet and receive user input regarding the method and system of the present disclosure. It is understood that FIG. 1 depicts one or more profiles, however, the method can include multiple profiles, users, registrations, etc. It is envisioned that a plurality of users or a group of users can register and provide profiles using the control system to share one or more trusted contacts with each other for agreed upon pick-ups or retrieval of one or more items 314.

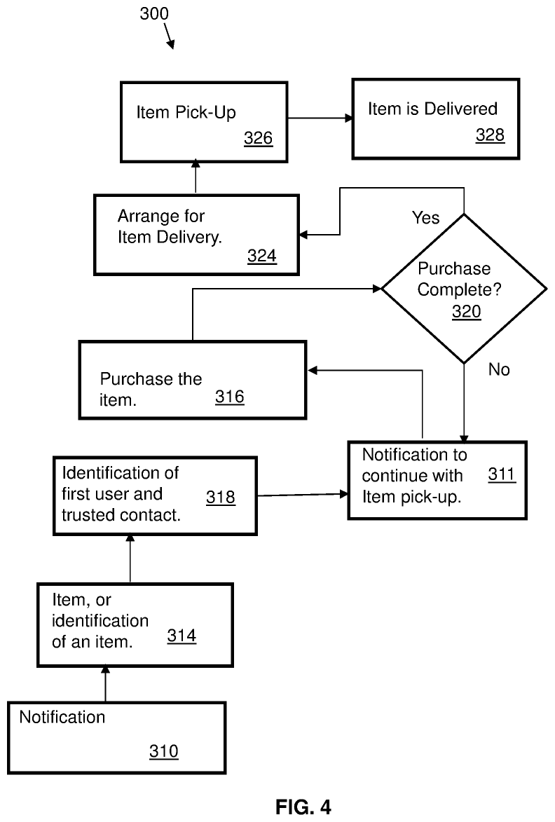

Referring to FIGS. 1 and 2, the method 100 includes sending from the control system and receiving, at a device 34 of a trusted contact 18, a notification 310 (see FIG. 4) for an item 314 pickup 326 or retrieval at an in-store location 19 on behalf of a first user 14, as in block 112. The notification 310 is in response to the current location of the trusted contact 18 coinciding with the in-store location 19 of an item pick-up for the first user 14 who is remote from the in-store location, as in block 116. The notification 310 can be sent by the method using the control system 70. In one example, the coinciding as described above can include the trusted contact entering a store or an area of a store that matches a location for an item pick-up, such as at a service desk for electronics, or a pharmacy counter in a large retailer.

The method includes identifying 318, at the respective devices of the trusted contact 18 and the first user 14, the trusted contact and the first user, as in block 120. Such identification can include the names of each, that is, the names of the first user and the trusted contact. The trusted contact is a person listed on a list of trusted contacts 84 for the first user 14. The list is stored on the computer 72 of the control system 70 and accessible by a program 66 on the first user's device 24 and the trusted contact's device 34. The list can be initiated and approved by the first user.

In one example, in the method 100, the first user and the trusted contact can agree to the trusted contact picking up the item in response to the first user being notified that the trusted contact is available to pick-up the item. Using the control system, the trusted contact and the first user can be identified to each other by sending a message, such as a text message, identifying each of the users to each of the respective devices. For instance, once the trusted contact and the first user are identified to each other in block 120, the method can ask for confirmation from the trusted contact that the trusted contact will pick up the item, and also ask for a confirmation from the first user that the first user wants the item picked up and will pay for the item. In response to the confirmations being received, the method can continue to block 124.

Referring to FIG. 2, the method includes, using the control system, offering or suggesting one or more payment options to the trusted contact on a display of the device of the trusted contact, as in block 124. In one example, the first user can pay for the item on-line, e.g., using the Internet, and select in-store pickup. In this scenario, the item is already paid for by the user, and only a pick-up needs to be arranged. In this situation, the offering or suggested payment option at block 124 can include designating that the item has been paid for and only requires pick-up. The method can provide a proof of payment so that the trusted contact can present the proof of payment when picking-up the item.

The method receives a selected payment option from the trusted contact, as in block 128, for instance at the control system. The method sends a notification to the device of the first user of the selected payment option, as in block 132, for example, using the control system. The notification can include, for example, a selection option, for instance, ‘approve’ or ‘disapprove’, of the payment option, for selection by the first user. The method includes receiving an approval of the selected payment option from the device of the first user and initiated by the first user, as in block 136. When the approval is received (block 136), the method proceeds to enable the selected payment option for the trusted contact to complete the payment option, as in block 140, for instance using the control system. When the approval is not received (at block 136), that is the first user does not approve the payment option, for example, rejects or disapproves the payment option, the method returns to block 124, and can offer or suggest another payment option.

The method includes confirming, using the control system, that the trusted contact has picked up the item for the first user, as in block 144. A confirmation can include, for example, a text to the trusted contact's device that the item has been picked-up by the trusted contact, or an automatic text sent by the method when the item is picked-up by the trusted contact. In another example, the confirmation can include a prompt sent to the trusted contact's device which provides options for selections indicating pick-up of the item. Such selections can include an option for the trusted contact to select ‘pick-up completed’, or ‘pick-up not completed’.

The first user is notified, using the control system, that the item has been picked up by the trusted contact, as in block 148. The method can end, in one embodiment, as shown in FIG. 2. A notification can include, for example, a text to the first user's device that the item has been picked-up by the trusted contact.

In one example, the method of claim 1, can include sending a reminder to the trusted contact to deliver the item. The reminder can be, for example, an alert and/or a calendar entry.

In another example, the method can include sending a prompt to the device of the trusted user to pick up the item, before sending a notification to the trusted contact, as in block 112. The prompt can include an option to pick up the item or to refuse. The trusted user can select one of the options. If the trusted user selects the option to pick up the item, the method can send the notification, as in block 112. If the trusted user rejects the option to pick up the item, the method can send a prompt to another trusted user to pick up the item.

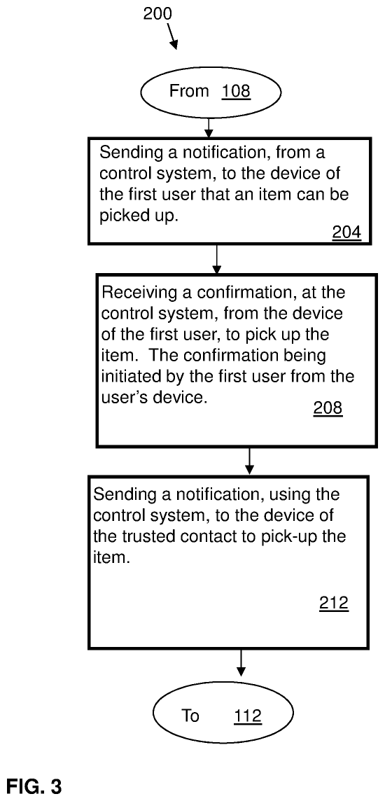

Referring to FIG. 3, in another example embodied in a method 200, the method can include sending a notification, from the control system, to the device of the first user that an item can be picked up, as in block 204 which follows from block 108 of FIG. 2. The control system can receive a confirmation, from the device of the first user, to pick up the item, as in block 208. The confirmation being initiated by the first user from the first user's device. The method then includes sending a notification, using the control system, to the device of the trusted contact to pick-up the item, as in block 212. The method 200 then continues to block 112 of the method 100 as in FIG. 2.

Referring to FIG. 4, a method 300 includes features of the embodiments of the present disclosure as depicted in the schematic block diagram of FIG. 4. The features are discussed in the embodiments of the present disclosure. By way of example, the method 300 provides another example of features of the present disclosure.

In another example, the method can initiate removing the item from a shopping list of the first user, in response to the first user receiving notification that the item has been picked up by the trusted contact. In another example, the method, using the control system, can initiate removing the item from a shopping list of the first user, in response to the control system receiving notification that the item has been picked-up by the trusted contact. The control system can subsequently send notification to the first user that the item has been picked up by the trusted contact.

In another example, the method can initiate sending one or more reminders to the device of the trusted contact to deliver the item to the first user, as in block 324 (see FIG. 4), after the item has been picked-up. For example, to remind the trusted contact to deliver the item to the first user. As a result, the trusted contact delivers the item, as in block 328 (see FIG. 4).

In one embodiment according to the present disclosure, the method can include generating profiles for each of multiple users, with user initiated data about the multiple users, that is, a user can initiate data for trusted contacts. With the consent of the user, the user, such as the first user, can upload data about themselves and trusted users. The trusted users can upload their data or approve themselves as trusted users for another user. Thus, the profiles can be populated with data for the multiple users. The trusted contacts for each of the users can be selected by each of the users, thereby the profiles include a list of trusted contacts for each of the users.

Regarding any collection of data with respect to the present disclosure, such uploading or generation of profiles is voluntary by the one or more users, and thus initiated by and with the approval of a user. Thereby, a user can opt-in to establishing an account having a profile according to the present disclosure. Such approval also includes a user's option to cancel such profile or account, and thus opt-out, at the user's discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user's authorization and consent.

In one or more embodiments of the present invention, a user(s) can opt-in or register with a control system, voluntarily providing data and/or information in the process, with the user's consent and authorization, where the data is stored and used in the one or more methods of the present disclosure. Also, a user(s) can register one or more user electronic devices for use with the one or more methods and systems according to the present disclosure. As part of a registration, a user can also identify and authorize access to one or more activities or other systems (e.g., audio and/or video systems). Such opt-in of registration and authorizing collection and/or storage of data is voluntary and a user may request deletion of data (including a profile and/or profile data), un-registering, and/or opt-out of any registration. It is understood that such opting-out includes disposal of all data in a secure manner.

In one embodiment according to the present disclosure, the method can include prompting the trusted contact that the item for the first user is ready for pickup. The prompting can include the identification of the first user. The method can include receiving confirmation from the trusted contact that they will pick up the item. The method can then send a notification to the first user that the item will be picked up by the trusted contact. The notification can include identifying the trusted contact. A payment amount for the item can be sent to the first user, after receiving notification that the trusted contact has initiated payment for the item. The method can include removing the item from a shopping list of the first user after the trusted contact has picked up the item. Such a shopping list can be initiated and saved in a user profile, or uploaded by the user. A reminder can be initiated for the trusted contact (for example, an alert and/or a calendar entry) to deliver the item to the first user.

In another example, the method can include suggesting payment options to the first user using a display of the device of the first user. The method can receive a selected payment option from the device of the first user which is initiated by the first user. The method can include sending a notification to the device of the trusted contact of the selected payment option. Thereafter, the trusted contact can use the selected payment option to purchase 316 the item.

In one example, the trusted contact (also referred to as the shopper) can pay or purchase 316 for the item using a single transaction with the shopper's items and the item for the first user bought together. The payment amount or the first user's item is sent to first user. In another example, the trusted contact can pay for the first user's item in a separate transaction. The payment amount for the item can be sent to the first user for reimbursement to the trusted contact. In another example, the payment amount for the item can be sent to the retailer from the first user using a payment application, and thus payment of the item is transacted and complete without input from the trusted contact. By way of any of the techniques, the item is payed for and the purchase is complete, as in block 320, and the method 300 shown in FIG. 4 proceeds to arrange for item delivery 324 by the trusted contact after the trusted contact has picked-up the item. If the purchase is not complete, the method 300 can send another notification 311 to continue with an item pick-up and purchase the item 316.

Also, referring to FIG. 1, the first user device and the trusted contact device 24, 34, respectively, include a computer 62, database 64, and operating systems and programs or an application 66. These features are shown generically for both systems.

The method 100 according to an embodiment of the present disclosure, can be incorporated in one or more computer programs or an application and stored on an electronic storage medium. It is envisioned that the application can access all or part of instructions necessary to implement the method of the present disclosure. The program or application can communicate with a remote computer system, such as the control system 70 via a communications network 50, e.g., the Internet, and access data, and cooperate with program(s) stored on the control system. In the embodiment of the disclosure shown in FIGS. 1 and 2, the method 100 is incorporated in a program or application 66, which can also be referred to as a software application 66 and stored on the first and second devices 24, 34, respectively. The application can communication with a control system 70 via a communications network 50. The control system 70 includes a computer 72 having a database 76 and one or more programs 74. In the embodiment of the disclosure shown in FIG. 1, the application 66 communicates with the control system 70 and the one or more programs 74. The control system includes the computer 72 which also has access to the database 76. The control system 70 includes a storage medium 80 for maintaining a registration and account data 82. In an embodiment, the method and system which incorporates the present disclosure includes the control system (generally referred to as the back-end) in combination and cooperation with a front end of the method and system, which is the application. The application is stored on a device and can access data and additional programs at a back end of the application.

It is also understood that the method 100 according to an embodiment of the present disclosure, can be incorporated in (Artificial Intelligence) AI devices, which can communicate with respective AI systems, and respectively AI system platforms. The platforms can be enabling for the AI systems and the devices that employ them. Thereby, such programs or an application incorporating the method of the present disclosure, as discussed above, can be part of an AI system.

Referring to the embodiments of the present disclosure, the disclosure allows an individual, which can be a trusted individual or trusted contact at a store to pick-up an item for a shopper. The trusted contact can already be at a physical store, and available to pick-up items for the shopper who is another trusted contact. The trusted contacts can be on a contact list. In one example, the shopper may have either: 1) placed an order and shared the order to be picked up by a trusted contact who may be at the physical store, or 2) have a ready-to-be-ordered items list in an online shopping cart and has shared the cart to be viewed and picked up by a trusted contact, when the trusted contact is at the physical store where the items may be available for pickup. When the trusted contact who is in the physical store triggers entry events using available micro-location, a lookup is initiated to determine if the current micro-location corresponds to any of the items within the shopping list of the shopper. If a match exists, then the method can alert the trusted contact to pick-up the item.

Additionally, micro-location technologies can allow the location of a shopper to be tracked at a fine grain. Such micro-location technologies can include, one or more of: beacons; WiFi (or wireless local area networking); and/or cameras. In one example, a first shopper can trigger an entry event for a specific or defined micro-location zone. When the entry event is triggered, a lookup can be initiated to determine if the zone matches any items from a trusted contact's list or shopping list. If no match is found in the list, the first shopper is not alerted, and if a match is found on the list, the first shopper is prompted by sending a message to the first shopper's device. The message can, for example, be a text message asking if the first shopper is willing to pick up the item in the zone.

In one option, after the order is picked up, a mechanism for the trusted contact to receive payments on an application of a mobile device for the value of the picked-up order can be initiated. For example, a payment application can be used transfer payment to the trusted user.

In another example according to the embodiments of the present disclosure, a trusted contact can be determined based on the type of item and a set of preferences. For example, a user may not want a trusted contact to pick up certain items. For instance, due to personal preferences, or wanting to maintain privacy for certain medications. In another example, other items can be designated as acceptable for any trusted contact to pick-up.

In embodiments of the present disclosure, a user can include, for example, but not limited to, persons who are unable to leave their homes due to a medical condition, or mobility challenges. Such situations can limit a person's ability to access products, shop, or pick-up items, whether the products are food items, clothing items, medications, etc. The present disclosure provides embodiments for assisting such persons. The assistance can be enabled using mobile devices, and also using AI systems which incorporate a user's preferences for household items, clothing, food, restocking techniques, etc. These examples do not limit the use of the embodiments of the present disclosure for convenience and efficiency for other users.

The flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

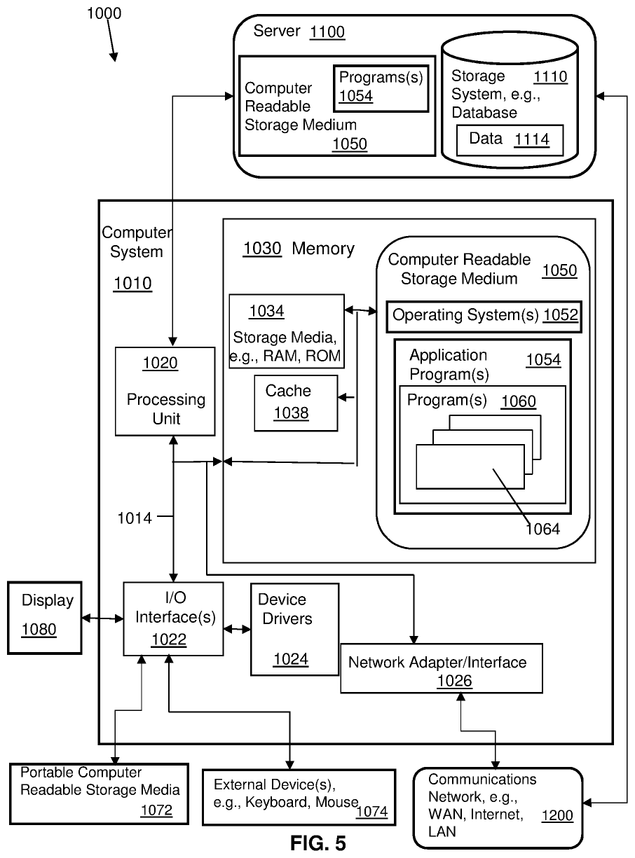

Referring to FIG. 5, a system or computer environment 1000 includes a computer system 1010 shown in the form of a generic computing device. The method 100, for example, may be embodied in a program 1060 embodied on a computer readable storage device, for example, generally referred to as memory 1030 and more specifically, computer readable storage medium 1050. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, the system or computer environment 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (1/0) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

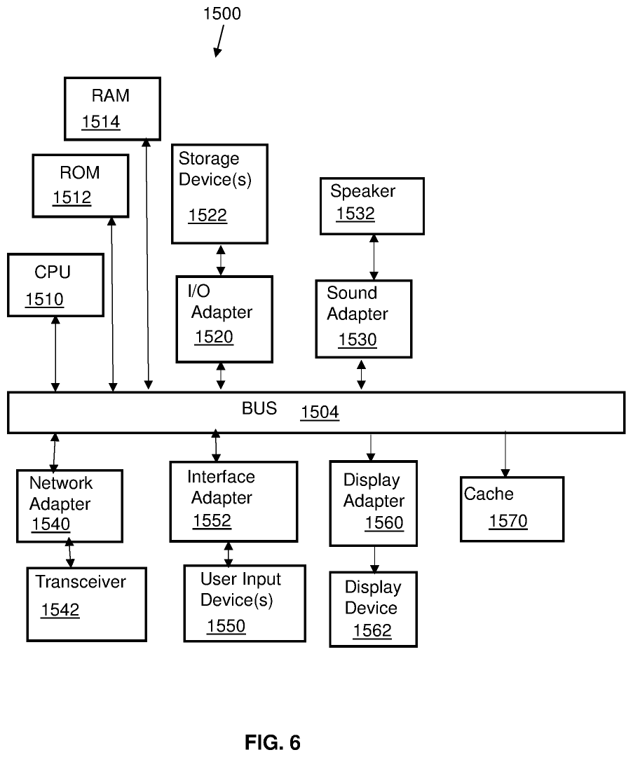

Referring to FIG. 6, an example system 1500 for use with the embodiments of the present disclosure is depicted. The system 1500 includes a plurality of components and elements connected via a system bus 1504 (also referred to as a bus). At least one processor (CPU) 1510, is connected to other components via the system bus 1504. A cache 1570, a Read Only Memory (ROM) 1512, a Random Access Memory (RAM) 1514, an input/output (I/O) adapter 1520, a sound adapter 1530, a network adapter 1540, a user interface adapter 1552, a display adapter 1560 and a display device 1562, are also operatively coupled to the system bus 1504 of the system 1500.

One or more storage devices 1522 are operatively coupled to the system bus 1504 by the I/O adapter 1520. The storage device 1522, for example, can be any of a disk storage device (e.g., a magnetic or optical disk storage device), a solid state magnetic device, and so forth. The storage device 1522 can be the same type of storage device or different types of storage devices. A speaker 1532 is operatively coupled to system bus 1504 by the sound adapter 1530. A transceiver 1542 is operatively coupled to system bus 1504 by the network adapter 1540. A display 1562 is operatively coupled to the system bus 1504 by the display adapter 1560.

One or more user input devices 1550 are operatively coupled to the system bus 1504 by the user interface adapter 1552. The user input devices 1550 can be, for example, any of a keyboard, a mouse, a keypad, an image capture device, a motion sensing device, a microphone, a device incorporating the functionality of at least two of the preceding devices, and so forth. Other types of input devices can also be used, while maintaining the spirit of the present invention. The user input devices 1550 can be the same type of user input device or different types of user input devices. The user input devices 1550 are used to input and output information to and from the system 1500.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

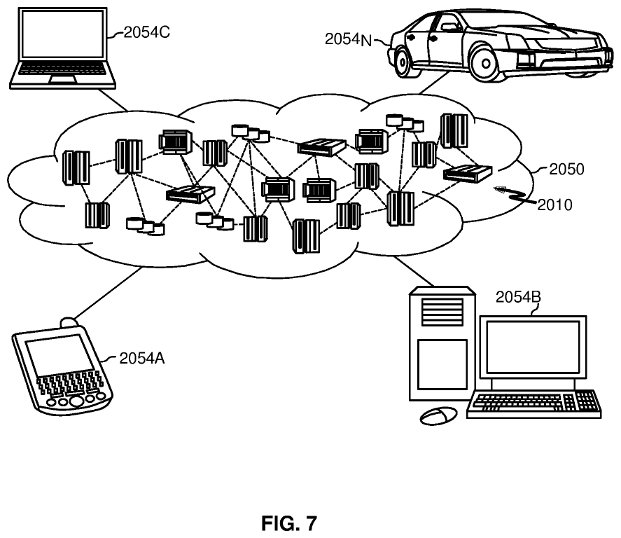

Referring now to FIG. 7, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 7 are intended to be illustrative only and that computing nodes 2010 and cloud computing environment 2050 can communicate with any type of computerized device over any type of network and/or network addressable connection (e.g., using a web browser).

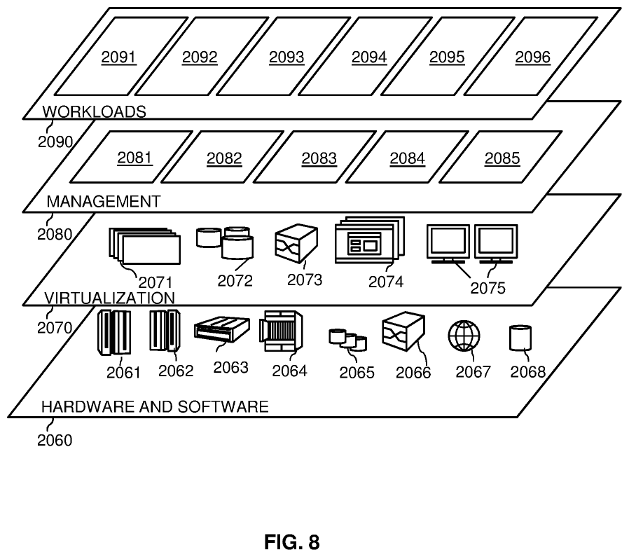

Referring now to FIG. 8, a set of functional abstraction layers provided by cloud computing environment 2050 (FIG. 8) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and enhancing shopping convenience using mobile devices and micro-location services for an item in-store pick-up by a user 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for enhancing shopping convenience using mobile devices and micro-location services for an item in-store pick-up by a remote user, comprising:
determining, using micro-location services, that a trusted contact for a remote user is in a location within a retail store corresponding to an in-store location of an item requiring in-store pick-up wherein the item is associated with the remote user;
sending, using a control system, to a device of the trusted contact, a notification for an item pickup of the item requiring in-store pick-up,
confirming, using the control system, that the trusted contact has picked-up the item for the first user; and
notifying the first user, using the control system, that the item has been picked-up by the trusted contact.

2. The method of claim 1, further comprising:
sending a reminder to the trusted contact to pick-up the item, in response to the trusted contact entering a micro-location zone associated with the item.

3. The method of claim 1, further comprising:
sending a reminder to the trusted contact to pick-up the item, in response to the trusted contact exiting a micro-location zone associated with the item.

4. The method of claim 1, further comprising:
in response to the pick-up of the item by the trusted contact, sending a reminder to the trusted contact to deliver the item.

5. The method of claim 1, wherein the trusted contact is determined based on the type of item and a set of preferences.

6. The method of claim 1, further comprising:
sending a notification, from a control system, to the device of the first user that the item can be picked up;
receiving a confirmation, at the control system, from the device of the first user, to pick up the item; and
sending a notification to the device of the trusted contact to pick-up the item.

7. The method of claim 1, further comprising:
removing the item from a shopping list of the first user in response to the first user receiving notification that the item has been picked-up by the trusted contact.

8. The method of claim 1, further comprising:
generating profiles for multiple users, with user initiated data about the multiple users, with the consent of the users, and populating the profiles of the multiple users with selected trusted contacts for each of the users, respectively, selected by each of the users, thereby the profiles including a list of trusted contacts for each of the users.

9. The method of claim 1, further comprising:
identifying, using the control system, at the respective devices of the trusted contact and the first user, the trusted contact and the first user, the trusted contact being a person listed on a list of trusted contacts for the first user, and the list being stored on a computer and accessible by a software application on the first user's device and the trusted contact's device, the list being initiated and approved by the first user.

10. The method of claim 1, further comprising:
prompting the trusted contact that the item for the first user is ready for pickup, the prompting including the identification of the first user;
receiving confirmation from the trusted contact that they will pick up the item;
sending a notification to the first user that the item will be picked up by the trusted contact;
sending a payment amount for the item to the first user, after receiving notification that the trusted contact has initiated payment for the item;
removing the item from a shopping list of the first user; and
initiating a reminder for the trusted contact to deliver the item to the first user, the reminder including one or more of, an alert, or a calendar entry.

11. The method of claim 1, further comprising:
suggesting payment options to the first user using a display of the device of the first user;
receiving a selected payment option from the device of the first user, and
sending a notification to the device of the trusted contact of the selected payment option.

12. The method of claim 1, further comprising:
receiving a confirmation initiated by the trusted contact of intention to pick-up the item, in response to the device of the trusted contact receiving the notification for the item pick-up;
offering payment options to the trusted contact on a display of the device of the trusted contact;
receiving a selected payment option from the trusted contact;
sending a notification to the device of the first user of the selected payment option;
receiving an approval of the selected payment option from the device of the first user and initiated by the first user; and
enabling the selected payment option for the trusted contact to complete the payment option.

13. A system for enhancing shopping convenience using mobile devices and micro-location services for an item in-store pick-up by a remote user, which comprises:
a computer system comprising: a computer processor, a computer-readable storage medium, and program instructions stored on the computer-readable storage medium being executable by the processor, to cause the computer system to:
determine, using micro-location services, that a trusted contact for a remote user is in a location within a retail store corresponding to an in-store location of an item requiring in-store pick-up wherein the item is associated with the remote user;
send, using a control system, to a device of the trusted contact, a notification for an item pickup of the item requiring in-store pick-up,
confirm, using the control system, that the trusted contact has picked-up the item for the first user; and
notify the first user, using the control system, that the item has been picked-up by the trusted contact.

14. The system of claim 13, further comprising:
sending a reminder to the trusted contact to pick-up the item, in response to the trusted contact entering a micro-location zone associated with the item.

15. The system of claim 13, further comprising:
sending a reminder to the trusted contact to pick-up the item, in response to the trusted contact exiting a micro-location zone associated with the item.

16. The system of claim 13, further comprising:
in response to the pick-up of the item by the trusted contact, sending a reminder to the trusted contact to deliver the item.

17. The system of claim 13, wherein the trusted contact is determined based on the type of item and a set of preferences.

18. The system of claim 13, further comprising:
sending a notification, from a control system, to the device of the first user that the item can be picked up;
receiving a confirmation, at the control system, from the device of the first user, to pick up the item; and
sending a notification to the device of the trusted contact to pick-up the item.

19. The system of claim 13, further comprising:
removing the item from a shopping list of the first user in response to the first user receiving notification that the item has been picked-up by the trusted contact.

20. A computer program product for enhancing shopping convenience using mobile devices and micro-location services for an item in-store pick-up by a remote user, the computer program product comprising a computer readable storage medium having program instructions embodied therewith, wherein the computer readable storage medium is not a transitory signal per se, the program instructions executable by a computer to cause the computer to perform a method, comprising:
determining, using micro-location services, that a trusted contact for a remote user is in a location within a retail store corresponding to an in-store location of an item requiring in-store pick-up wherein the item is associated with the remote user;
sending, using a control system, to a device of the trusted contact, a notification for an item pickup of the item requiring in-store pick-up,
confirming, using the control system, that the trusted contact has picked-up the item for the first user; and
notifying the first user, using the control system, that the item has been picked-up by the trusted contact.
